(19) United States
(12) Patent Application Publication
(10) Pub. No.: US 2011/0100405 A1
(43) Pub. Date: May 5, 2011

(54) INSTALLATION FOR DEFENSE OR PROTECTION ALLOWING THE CONTROL OF THE ENTRY OF PEOPLE

(76) Inventor: Gilbert Fournier, Montivilliers (FR)

(21) Appl. No.: 12/735,448

(22) PCT Filed: Jan. 16, 2008
(86) PCT No.: PCT/FR2008/000052

§ 371 Date: Dec. 27, 2010

(51) Int. Cl. E04H 15/02; E06B 11/08; G06K 5/00

(52) U.S. Cl. 135/96; 235/382

(57) ABSTRACT

The invention relates to light structures for the total video monitoring and the remote control of the system, and for the pre-recording of access badges, characterised in that they include booths to be placed on the ground, or slightly above the ground, that comprise a control or survey room oriented towards the outside and, adjacent thereto, 1 to 7 turnstiles or rotating drums oriented towards the entrance or the exit and arranged on a platform that is optionally covered by protection means and provided with signalling panels.

This invention relates to installations for defense or protection, allowing the control of the entry or way out in the areas with risks, namely the industrial buildings or tertiary activities buildings.

More precisely it has as a subject matter, mobile buildings having an access air lock allowing the control by means of identification devices, of some people and allowing entry or way out for pedestrians within a closed area, such as an industrial building, a tertiary implantation or even factory with industrial risks of the SEVESO Risks type.

In its European patent application Ser. No. 07/01186, the applicant has already disclosed and claimed—a security device which allows the control of the entrance, and the way out, of mobile elements, namely pedestrians within the enterprise, the yard, the warehouse or storage site wherein it includes a flimsy building fitted with an access airlock, bound to a closing device on both sides of this building and showing adjacent to that, one or several rocking turnstile(s) insuring the control of ways, preferably from two to four tripods rocking turnstiles.

A supplemental characteristic resides in the fact that the turnstiles are equipped with a reading system of magnetic card at one end of the access and these ones cannot rock unless the reading of the magnetic card indicates that the bearer is allowed to penetrate in this closed area.

The protection device also includes, adjacently to the flimsy building, optionally mobile stopping devices, intended to insure the comings of employees or fully authorized visitors.

The device also includes an access slope located in front of the flimsy building, which screens the moving of people and provides a way of coming to the entry or the way out by means of an indicator of way of passage.

The said access slope may also include an amovible identification plate which constitutes a means for selecting the entries or a means for informing for the entrants or coming people the needs for the entry. This flimsy building will be of the barrack or bungalow type including a threshold for accessibility and showing from two to four access turnstiles placed out with an interval allowing the easy crossing of an individual.

The flimsy building is moreover constituted with a control room which allows the screening or the filming of the entrances and which guarantees the functioning of the access turnstiles.

The turnstiles may rotate in both ways, either to allow the entry or allow the way out. They are controlled by a device of verification of the type of magnetic card including a comparison between the identity and/or the essential features of identification or the data of timetable or localization of the bearer. If the data contained in the device for verification are not in accordance with the notices, the turnstiles will not be able to rock, and to let free the passage. Optionally it maybe equipped with an acoustic or luminous alarm device showing to the control employees a fortuitous or intended disturbance in the functioning of the turnstiles. The turnstiles are constructed in such a manner that only one person may cross it at the same time. They may by fitted with a device insuring the crossing to partially sighted people or disabled people.

This defense or protection setting up according to the invention finds a specific utility to insure the screening and the sorting in the entries and in the comings out of the workforce or the visitors, in a company to avoid that outsiders to the staff or still even unauthorized people may cross in the building and may be in a position to provoke deteriorations or to size information on the nature, the functioning or the use of the equipment, the means of production or the storage present in this company or still even on the nature of significance of production means in a certain workshop.

Particularly this control or defense device is intended to avoid any risk with an industrial espionage while making more difficult any intrusion or coming out of any unauthorized people.

This invention addresses to the field of mechanics and more precisely to the field of safety.

It has more precisely as the subject matter new types of fittings and sites made secure i.e. allowing screening the crossings in such buildings.

More specifically it has as a subject matter new types of flimsy buildings allowing the total video survey and the remote control of the system the pre-recording of the access swipe card to make easier the quickness for the crossing or coming out and the decrease the use constraints for the client.

This invention more particularly relates to flimsy buildings like shacks laid out in the ground or slightly raised, including a room for the control and the survey oriented to the outside, some turnstiles directed to the coming out, a platform for the coming out located at the inside, the whole setting being covered by a means for protecting, having luminous roads signs.

The control or survey room is a flimsy building having a working surface, a hatch forming window, a massive door opening to the outside, stationery material namely a movable cupboard having several drawers.

This barrack may further include a side window having bars. The deck of this building is topped with a video camera located in a corner of this building and outside floodlights. According to a specific embodiment of this invention, this room may still have an other hatch window oriented to the inside, in such a manner this control or survey room is equipped with two or three windows, optionally provided with bars situated in the front of the building or on the free side of the building and on the internal side of building.

The windows are provided with motorized rolling shutters. The control and survey building is located, adjacently to is, with a covered area, closed with motorized rolling shutters located on the anterior and the posterior side of this area and having panels hanging above the way out at about six feet off the ground, indicating with a luminous cross whether the passage is possible or on the contrary, prohibited.

This area includes on the back and the front side, an approach ramp divided on several segments corresponding to the defined number of turnstiles or of swivelling ramps the rotation of which is made possible when possessing a mechanical or electronic safety device such as a magnetic card. The rotation of the turnstiles may only be achieved when placing the safety device in the reading member. Inversely, the coming out from the building may only be performed when the magnetic card is set up, the reading of which allows the flipping over of the turnstiles.

According to another embodiment of the invention the covered area includes in place of the turnstiles, side gates provided with magnetic cards readers. These side gates manually move but their opening is under control with a magnetic card which allows the passage for entry or for coming out. In this case the tripod turnstile is with double ways and includes two card readers, one allowing the entry, the other one the coming out.

The side gate is secured with a vertical ramp embedded to the ground and located in the center of the area or against the control building and fitted with several hinges allowing the rotation of the side gate. It includes one or several passages, of entry and at each access the side gate includes a mean for closing, such as a lock to block up the passage.

According to a third embodiment of the invention, the covered area is controlled by the presence of two rotative revolving doors fitted with around ten horizontal jambs located around the revolving pole. In this manner the access to this area is totally impossible when somebody does not have available the card which makes free the rotation mechanism if impulsion of this ensemble.

In this configuration the adjacent control building is not subjected to any alteration.

In a fourth embodiment of this invention the covered area is provided with only one rotative revolving door as well as a side gate and thus it is possible to canalize the people which want have access through the rotative revolving door and those which want enter or come out through this side gate.

In this fourth embodiment of the invention, the control building is provided with a lifting bar the control of which is performed from the inside of this building or in adjacence to the building. The staff which occupies this building may control the raising either from the inside of the building or out going from the building. The control may be manual by unblocking a counterweight or mechanical while setting off an electrical motor or any other type of motor. The lifting barrier may be simple or double and is located at a height which corresponds to the upper part of the bonnet of the car which wants enter, i.e. about one meter from the ground.

The lifting of the barrier may also be controlled by a photo electrical or ultra-sonic cell located at the basis of the control building, which will provide with the impulsion needed for this lifting.

The Adjacent for this lifting covered area possesses three tripod turnstiles which control the entry of the pedestrians and a tripod piece revolving in the opposite way to insure the coming out of the pedestrians.

According to a fifth way of performance of this invention, the covered area includes on one side a side gate and on the other side two tripod gates functioning in inverse way, on the other side. In this embodiment the most significant entry is that allowed by the side gate. It may also be possible to access to this area through the tripod and to go out again through the sole reverse tripod barrier.

According with a sixth way of performance of this invention, the covered area is wholly occupied with tripod barriers alternatively opening to the inside (two tripods) then another to the outside separately from the other tripod by means of a wall or by a supporting separation. It may be thus placed on line seven tripods one, of which is a double way tripod which may rock to the access or to the exit as a function of the reading of the magnetic card (reader of entry magnetic card) or reader for exit (magnetic card). It has been set up above this area floodlight, namely halogen headlights, to insure the lightening. A survey camera is located within this area. It has been set up on the whole perimeter, motorized rolling shutters. This area also includes an approach ramp removable for access and another approach ramp allowing the coming out.

In a seventh way of performance of this invention, the covered area includes three rotating revolving doors, one of which allows the coming out and the two other ones allow the access. One of these revolving doors may be rotative in the two ways while including a magnetic card reader allowing the exit and a magnetic card reader allowing the entrance located on each side hanging luminous panels steer the entering staff or the coming out staff.

In a eight way of performance of this invention the access device includes four tripod turnstile rotating in the ways with an entrance reader for magnetic cards on one side and an exit reader for magnetic card on the other end. In this embodiment the control building is fitted in a different manner. The access door is a massive half-door with adjustable counter.

The center of this room is occupied with a reception desk including a storage unit and a shelf for computer (CP). A large number of seats are placed in this room to allow the visitors to install or work or receive messages.

Such arrangement is particularly appropriated for the welcomes and festivities with a happening character. It allows for a high number of people to be welcomed at the same time.

In a similar embodiment it has been foreseen a higher number of rocking tripods, for example seven turnstiles, three of which rotate to the internal part some of turnstiles as bearer of two reading devices such as they may turn in the direction of the exit and in the direction of the entrance.

Accordingly a screening of the visitors is achieved, some ones accessing to the fittings, the other ones being intended to go out. Accordingly scrambles or packing down, when people are too numerous and need to be canalized, are avoided.

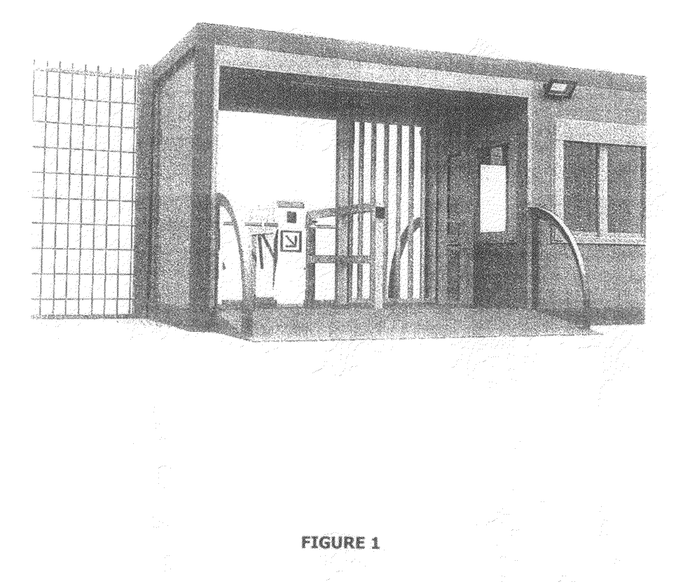

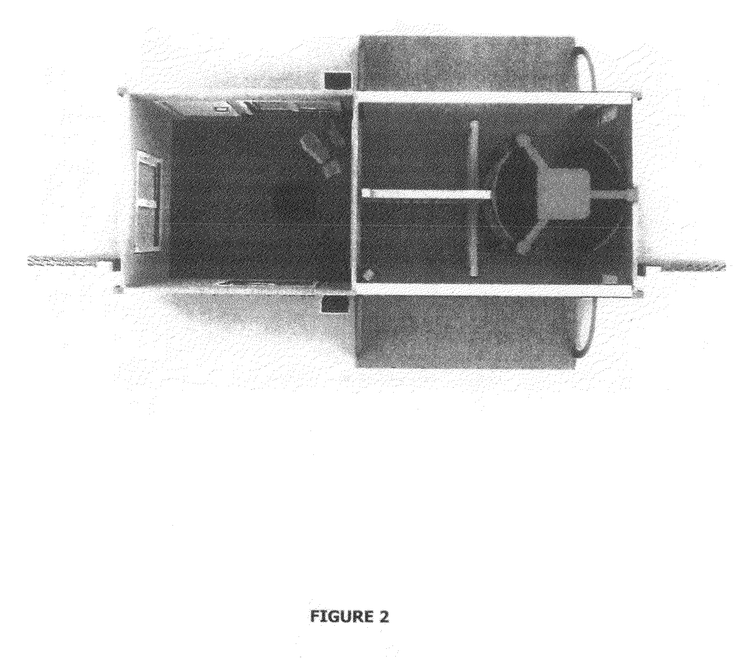

FIGS. 1 and 2 herein after presents provide with a general view of the building according to the invention either from front side either from above.

On the back side of the building access ramps divided n partition corresponding to the possible ways of passage.

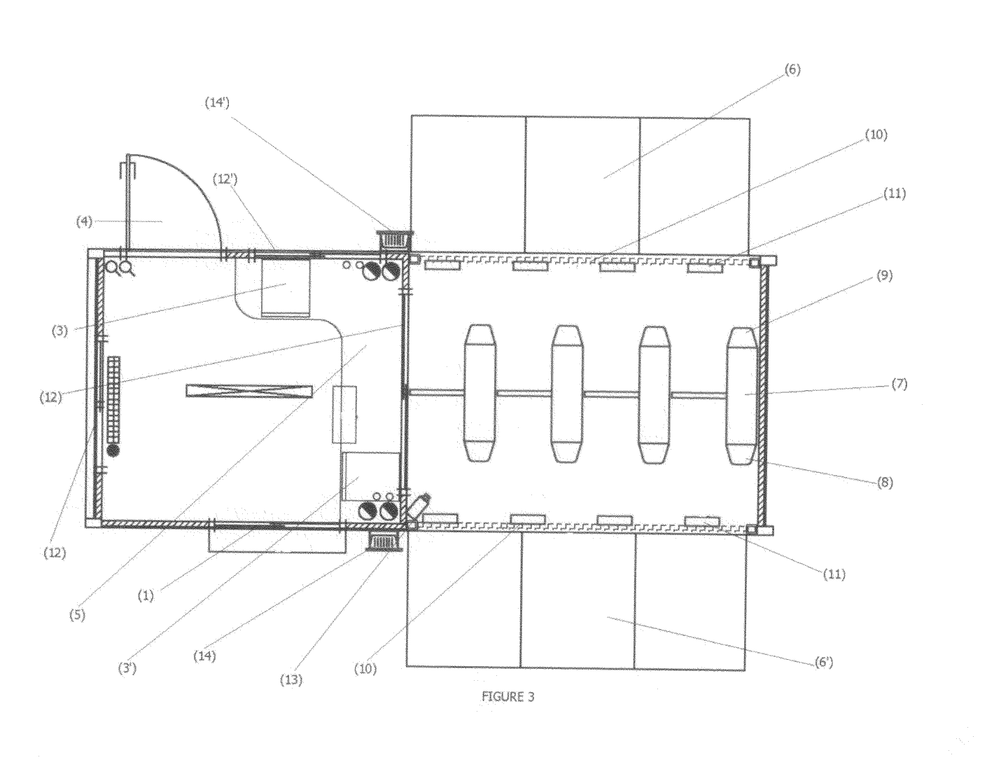

FIG. 3 provides a picture of the control building ant the access devices. They are pictured as (1) the window of the swichels, a (2) shelf for computer keyboard as (3) and (3′), a piece of furniture with cashbox drawers as (4) the access door opened to outside, as (5) a working plan as (6) and (6′), the movable approach ramp as (7), a rocking double way tripod as (8), a reader for magnetic card allowing the exit as (9), a reader for magnetic card for the entry as (10), motorized rolling shutters as ( ) and as (11) the luminous plates for orientation. As (12) (12′) they have been pictured the protection bars placed on windows, as (13), a video camera with fling and recording and as (14) (14′) on each sides of the building spotlights outside.

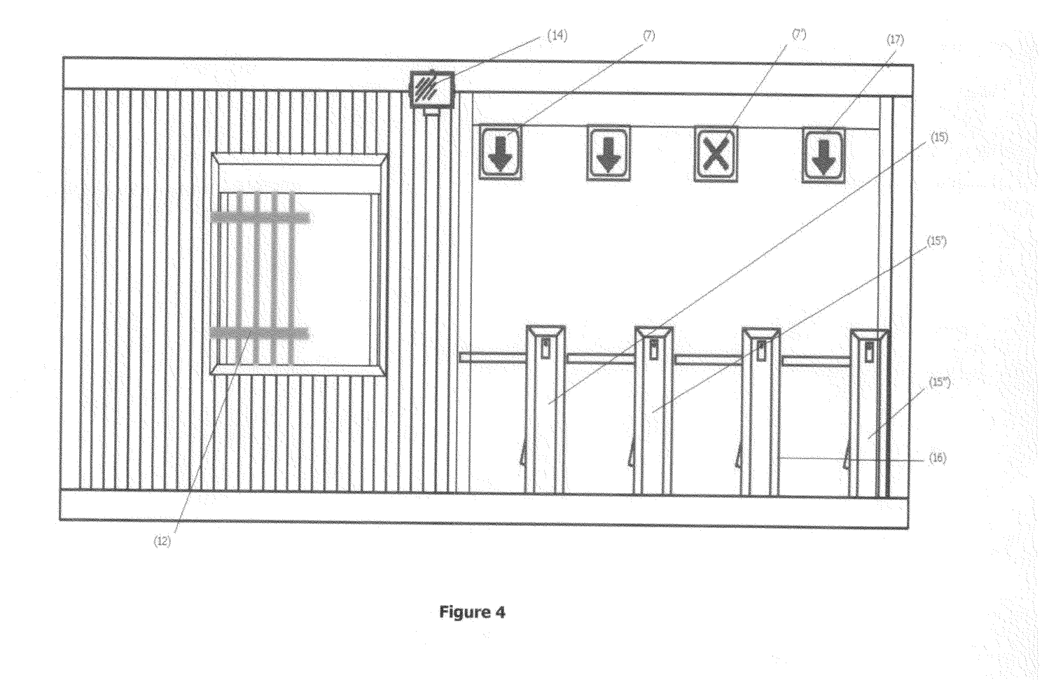

FIG. 4 shows the protecting system access from the front with the control building fitted with bars at one window (12), the entry tripods (15) (15′) (15″) and the exit tripod (16) as well as the orientation panels (17) (17′). The control building is fitted with a spotlight (14).

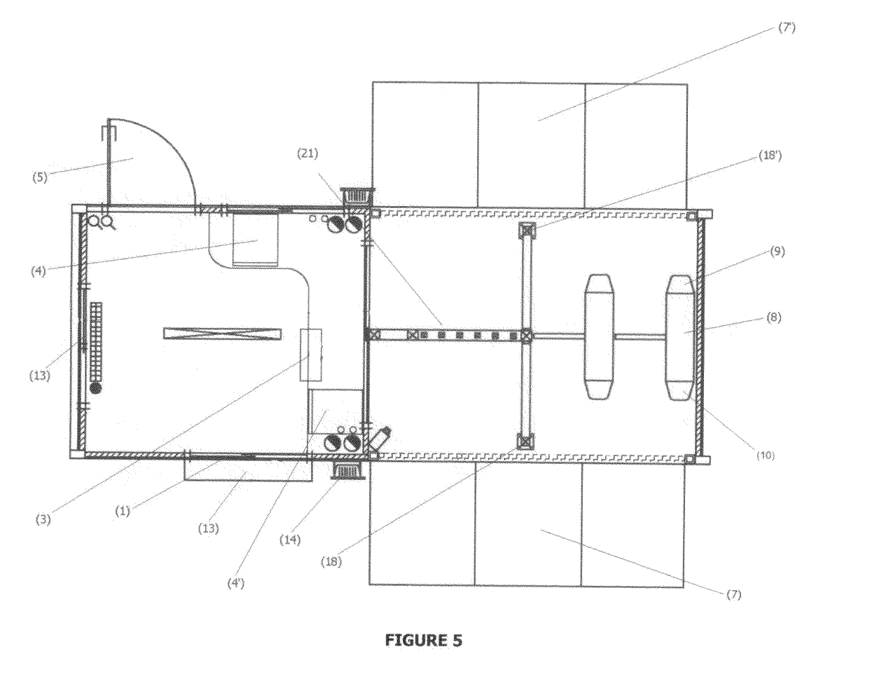

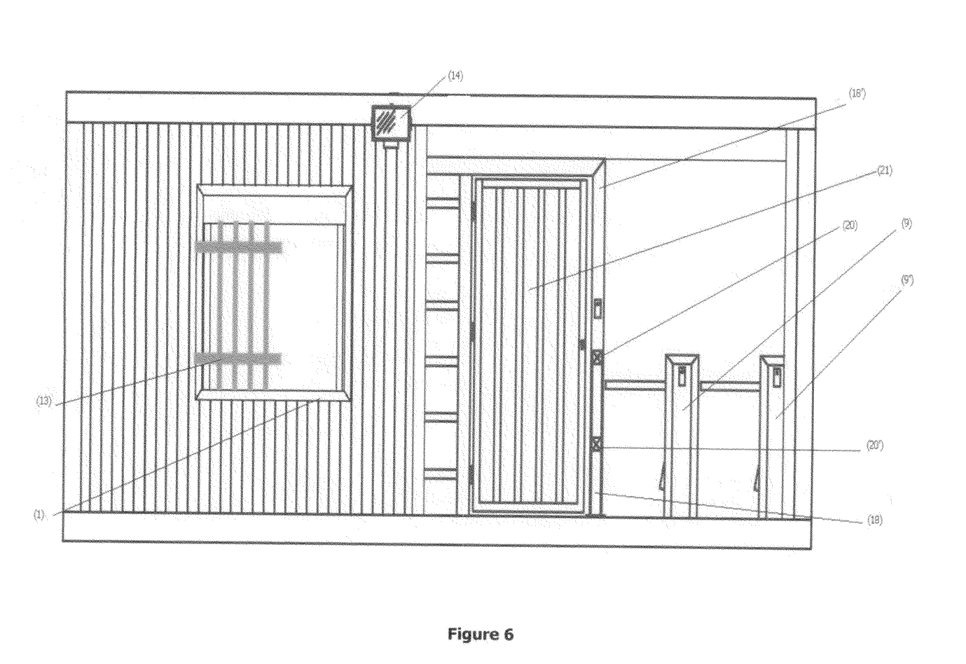

FIG. 5 shows an embodiement including an access side gate (21) placed in the middle of the entry of the covered area. They have been pictured as (18) (18′) the fastening pole and as (19) (19′) the jambs of this side gate.

The access thresholds are shown as (7) (7′) and the tripod turnstile as (8) provided with two magnetic cards readers as (9) and (10). They have been also pictured as (20) and (20′) the magnetic card readers located on the side gate one for the access, the other one for coming out.

FIG. 6 shows a view in a plane of the control building and in adjacent manner, the side gate (21) fitted with two magnetic cards readers as well as two tripod turnstiles (8) (8′)

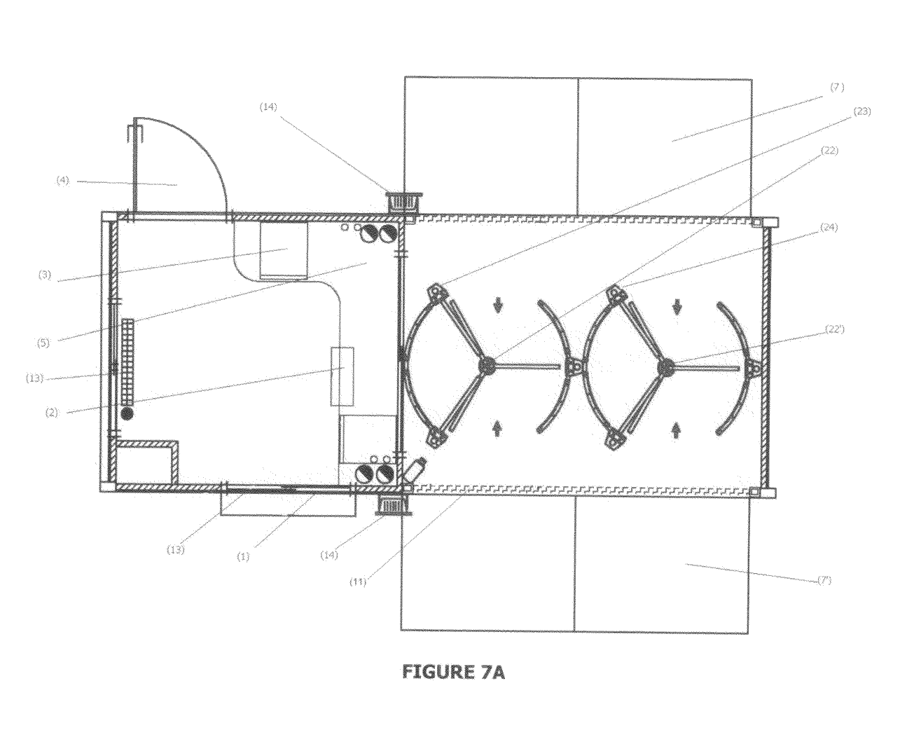

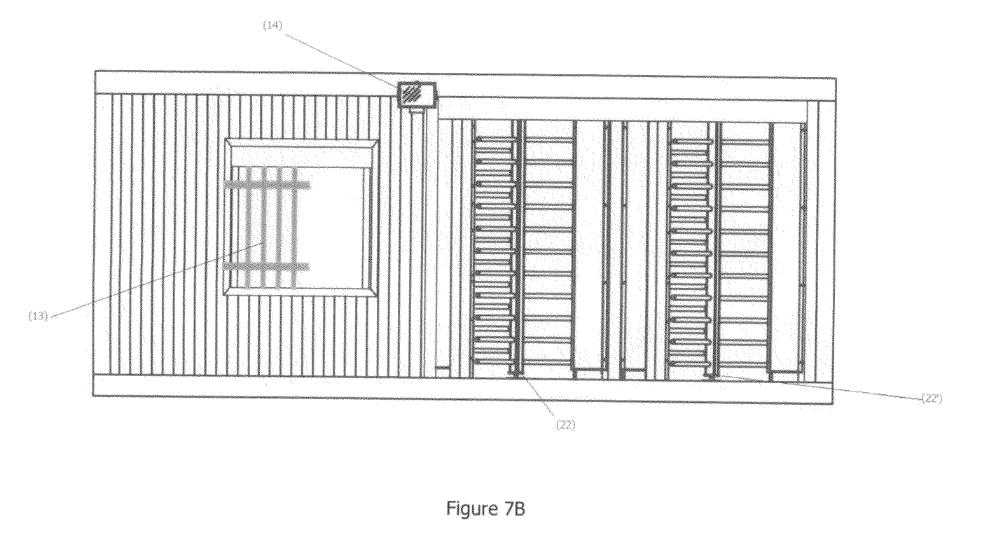

FIG. 7 shows viewed from above of the setting according to the invention, evidencing in the covered area, two rotative revolving doors equipped with horizontal arms. The two rotative doors secured each other are equipped with a magnetic card reader for the entry (25) and a magnetic card reader for the exit (24). These two rotative revolving doors are fastened in the ground through a central axis (22)

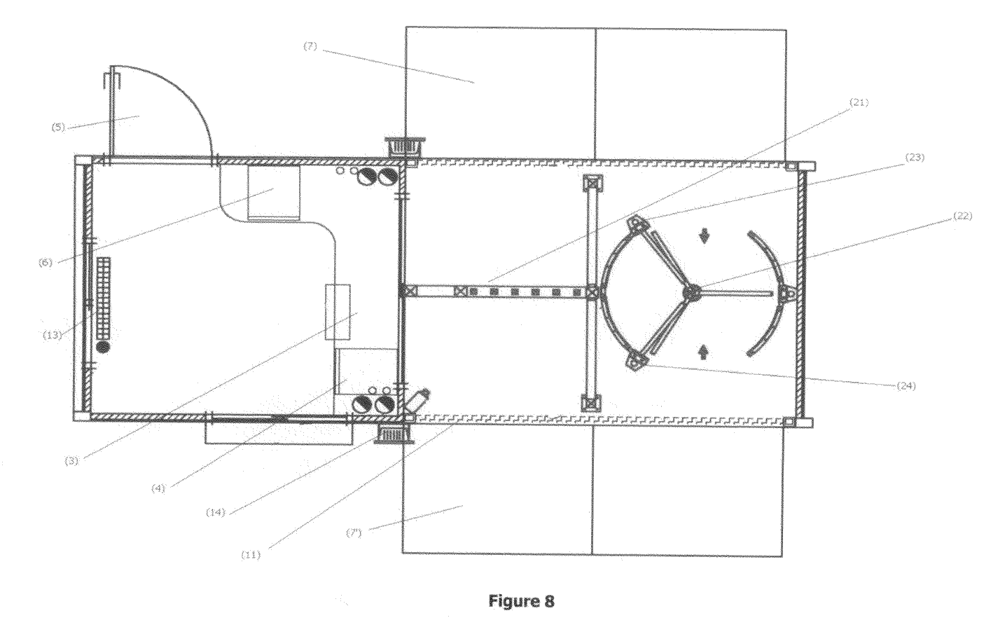

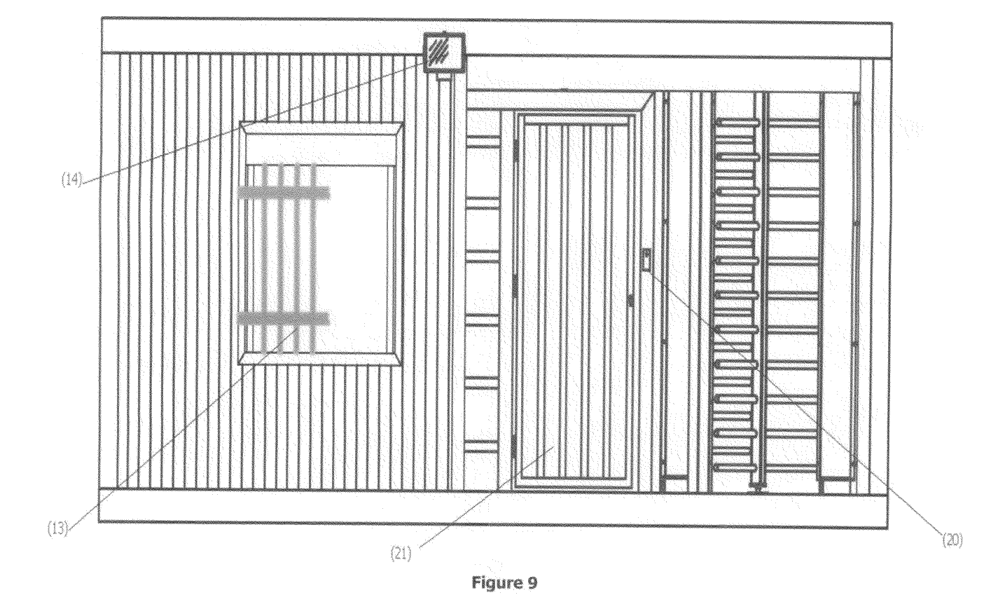

FIG. 8 and FIG. 9 illustrate an embodiement in which the access covered area includes a side gate (22) and in adjacent manner a rotating revolving door (23). The rotating revolving door (23) is provided with a magnetic card reader (24) which allows the coming out or the entry of the pedestrians. The side gate allows the opening by hand but unlocking is performed through a magnetic card reader.

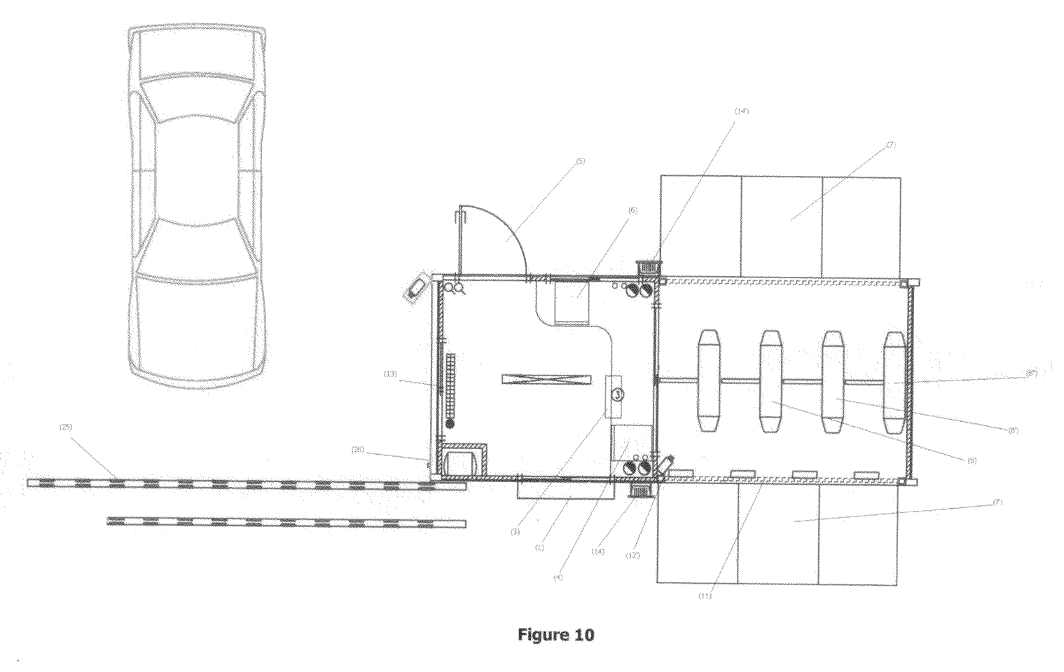

FIG. 10 shows an embodiement according to which the control building is provided with a lifting barrier (25) controlled by security cells (26).

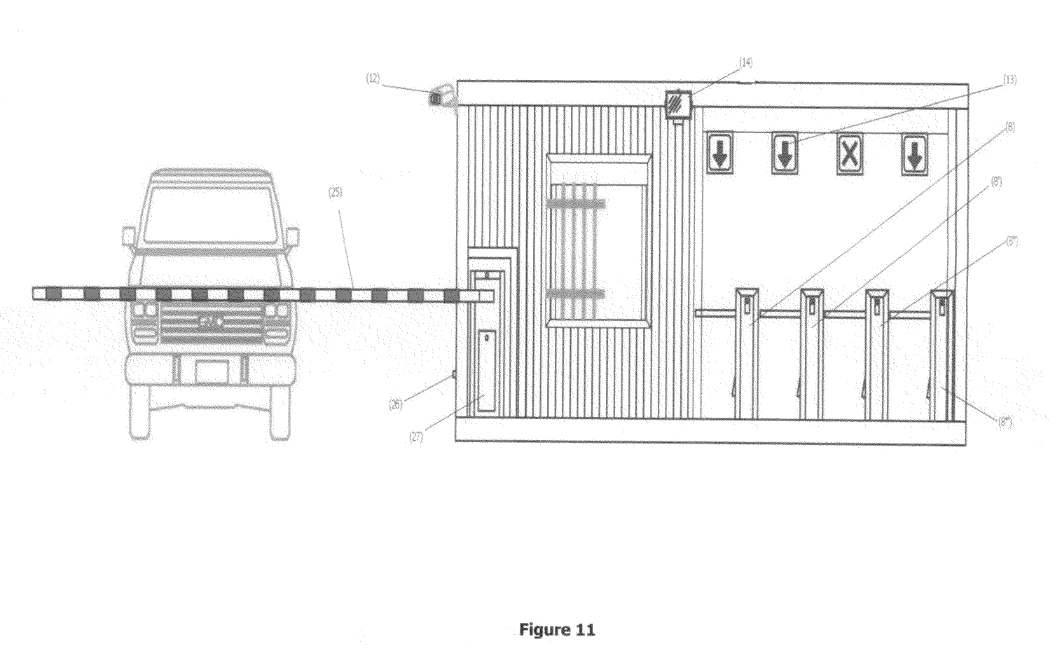

FIG. 11 shows that the lifting barrier is secured with (27) provided with an electric motor controlled with the photoelectric cell (26).

In this embodiement four tripod turnstiles are represented, three of which allowing access and the fourth one allowing the exit.

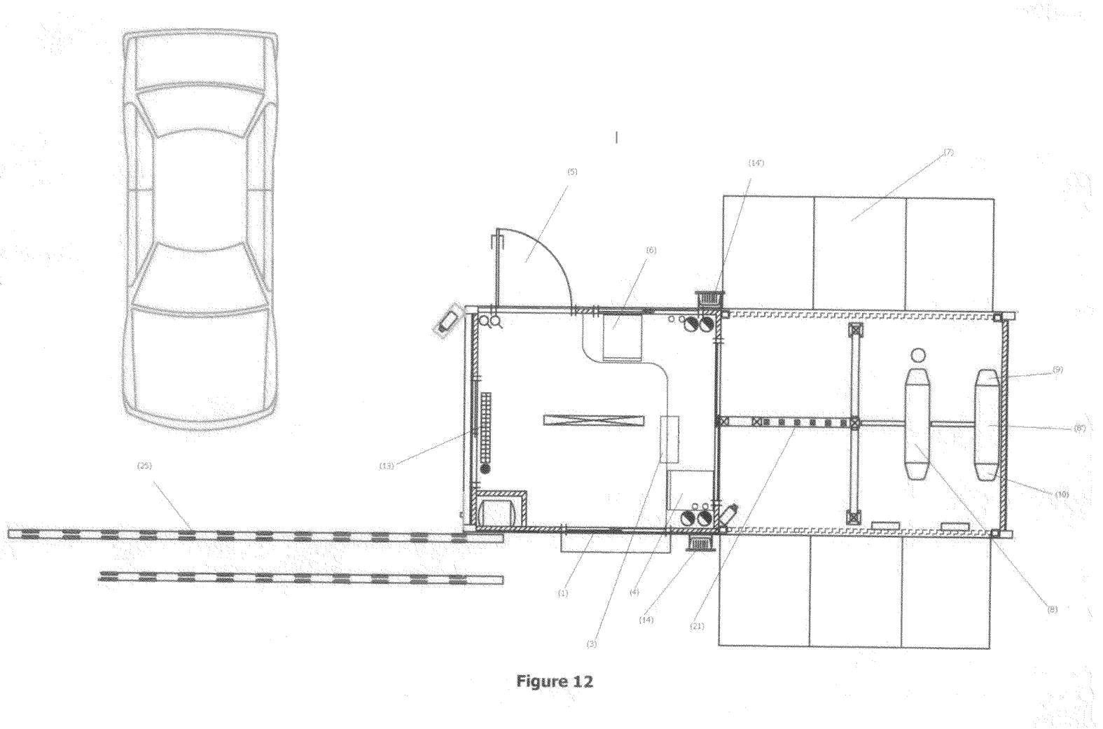

FIG. 12 provides an illustration of the embodiement in which the covered area includes at the same time a side gate (21) and shows tripod turnstiles (8) (8′).

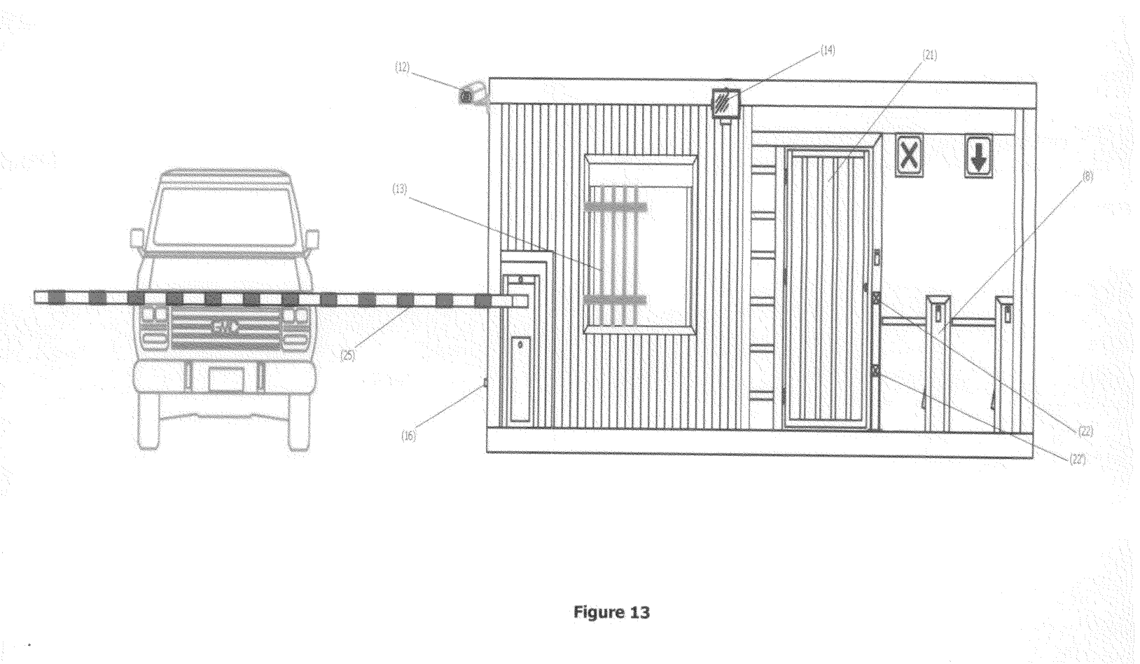

FIG. 13 shows viewed in a plane the control building (21) equipped with a lifting barrier activated with a photoelectric cell (16), the lifting barrier is arranged at one meter above the ground.

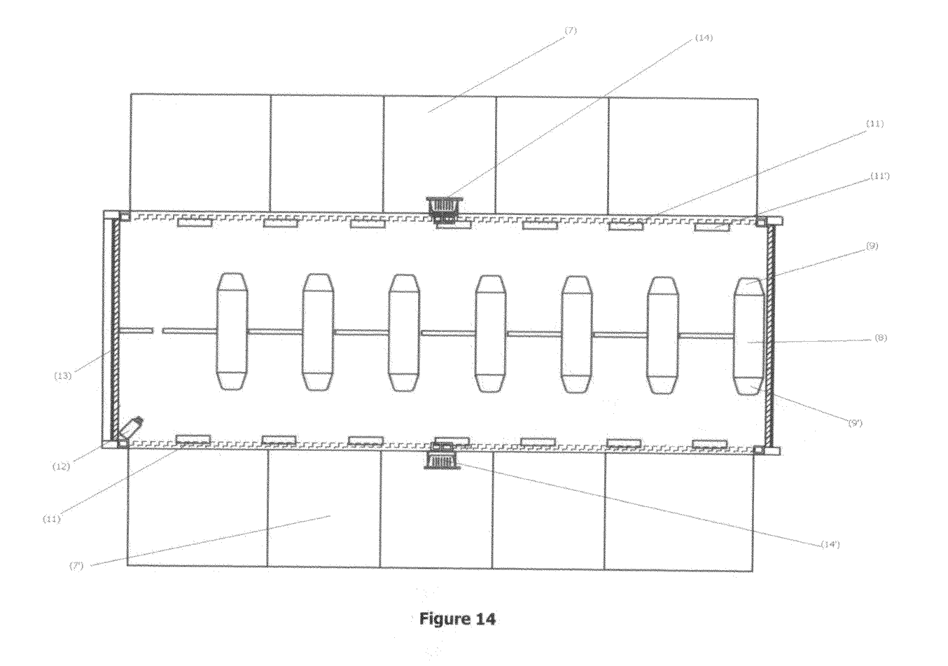

FIG. 14 illustrates an embodiment seen from above including tripod double-way turnstiles (8) provided with a magnetic card reader for the exit (9) and a magnetic card reader for the access (10). The significant covered area is equipped with rolling motorized shutters. The access to this area is made easier by an approach ramp (7) removable at the entry side and the exit side. The covered area is equipped with luminous directional panels (11), with halogen headlights (14) and with a video survey camera (12).

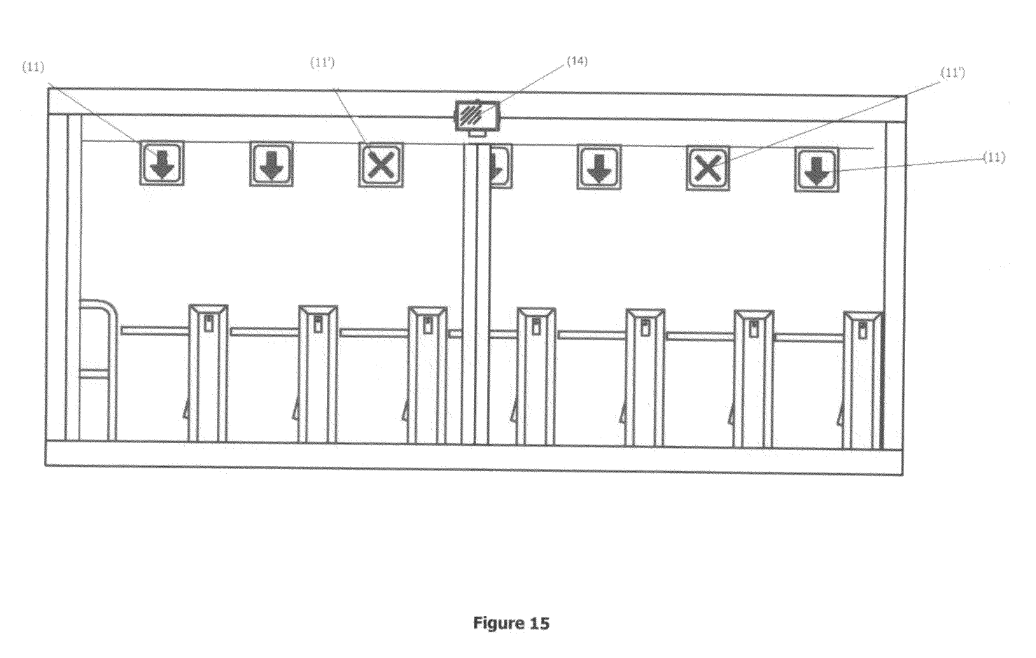

FIG. 15 shows the same embodiment but seen from the front, such embodiment allows to left a large area permitting the gathering of a great number of people, in view of a festivity, a celebration or a demonstration.

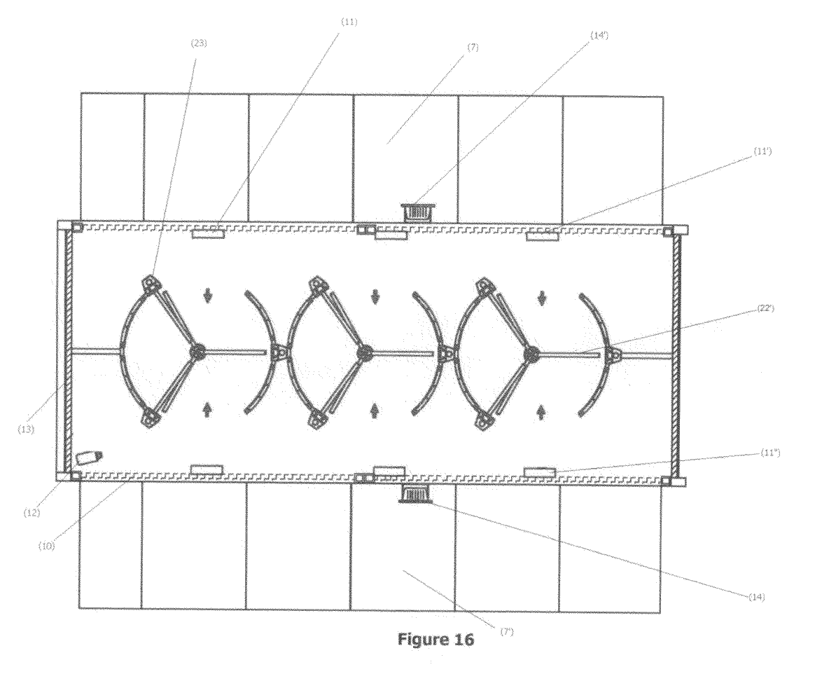

FIG. 16 shows viewed from above, the fitting out of such premise with only rotative revolving doors (23), two revolving doors turning to allow the exit, the other revolving door allowing the access to this area.

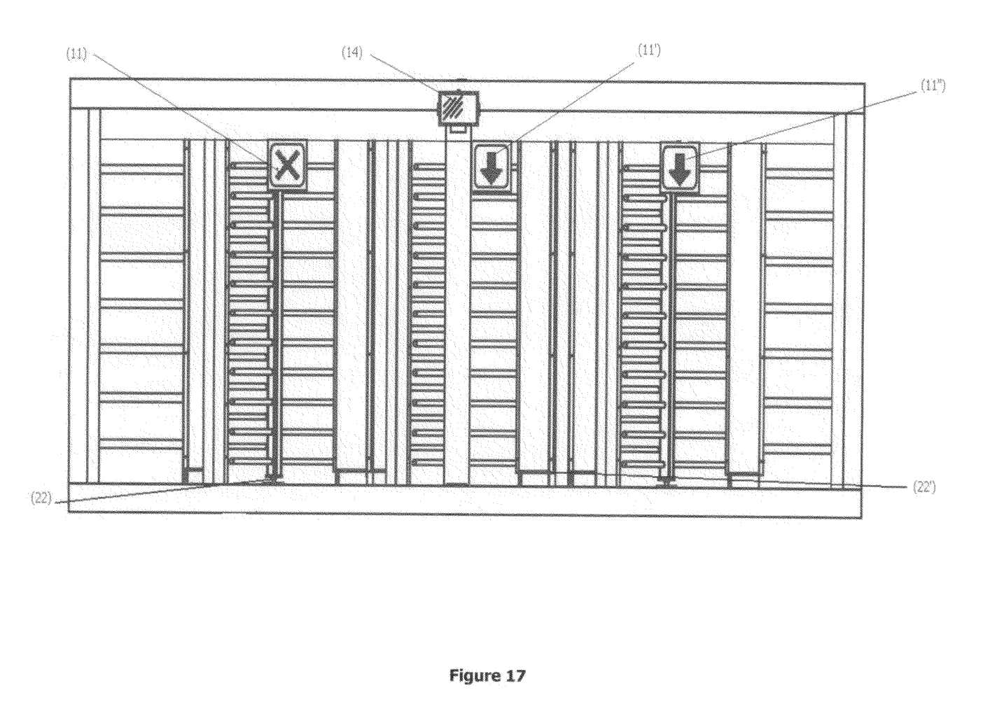

FIG. 17 shows the same arrangement seen from the front with three rotative revolving doors fitted with magnetic card reader devices (24), one of the revolving doors being rotative in the two ways.

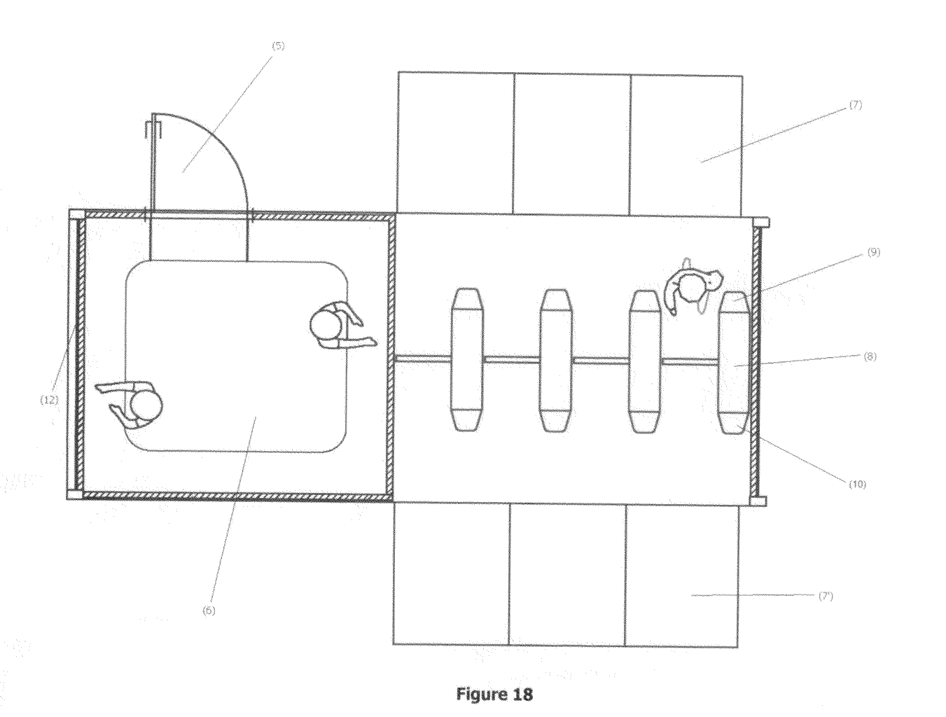

FIG. 18 shows an embodiment intended for a festivity. In the control room at least two people are seated at the table around the reception bank including cupboards and sills for personal computer. It has been also depicted the passage for a pedestrian in front a tripod turnstile (8) provided with a magnetic card reader for the exit (9).

1. Flimsy buildings allowing a total video survey, and the remote control of the system, prechecking of the magnetic cards for access, wherein they include a barrack arranged on the ground or even slightly raised, wherein they have a control or survey room oriented to outside and having in adjacence a determined number of turnstiles or rotative revolving doors ranging from 1 to 7, directed to the entry or to the exit, placed on a platform which is optionally covered with a protecting means equipped with signalization panels.

2. Flimsy buildings according to claim 1 wherein a production shot, a hatch-forming window optionally fitted with bars, a stationery one or several storage unit(s) of the type movable cashbox, and a video camera and spotlights located in the deck at one corner of the building and obturating means of the curtain type which have been disposed therein.

3. Flimsy buildings according to claim 1 which include on the front side and on the back side of the building access ramps divided in two segments corresponding to the number of possible passage ways.

4. Flimsy buildings according to claim 1, wherein the covered area included a side gate rotative around a fastening mast and equipped with magnetic card readers.

5. A flimsy building according to claim 1, wherein the covered area is further equipped with tripod turnstiles with double control of rotation.

6. Flimsy buildings according to claim 1 wherever the tripod turnstiles are partially or totally replaced with rotative revolving doors equipped with a magnetic card reader system.

7. Flimsy buildings according to claim 1 wherever the control building is equipped with a lifting bar which allows the entry or the way out of a vehicle, the control of which is insured from inside of the building or in adjacence of the building.

8. Flimsy buildings according to claim 1 wherein the tripod turnstiles or the rotative revolving doors are controlled by a magnetic card reader system.

9. Flimsy buildings according to claim 1 wherein the controlling devices of the turnstiles or rotative revolving doors, are of the magnetic card type including date in the identity, the essential data for identification, the data in hour and/or on the localization of the bearer.

10. Flimsy buildings according to claim 1 wherein the access side gate is joined side by side to the tripod turnstile or to a rotative revolving door.
